(19) United States
(12) Patent Application Publication
(10) Pub. No.: US 2016/0340887 A1
(43) Pub. Date: Nov. 24, 2016

(54) HYDRAULIC MIXER INLET FOR A SEPTIC OR INCEPTOR TANK

(71) Applicant: CLEARFORD INDUSTRIES INC., Ottawa (CA)

(72) Inventors: Kevin BAILEY, Ottawa (CA); Mathew BAILEY, Ottawa (CA)

(73) Assignee: Clearford Industries Inc., Ottawa (CA)

(21) Appl. No.: 15/115,202

(22) PCT Filed: Jan. 29, 2015
(86) PCT No.: PCT/CA2015/050061

§ 371 Date: Jul. 28, 2016

Related U.S. Application Data
(60) Provisional application No. 61/933,506, filed on Jan. 30, 2014.

(51) Int. Cl. E03F 5/10; F16L 55/07; E03F 5/14; F16L 43/00

(52) U.S. Cl. CPC E03F 5/105; F16L 43/00; F16L 55/07; E03F 5/14

(57) ABSTRACT

The present invention provides a hydraulic mixer inlet for a septic or interceptor tank. The hydraulic mixer has an inlet for receiving organic containing liquid such as sewage from a source disposed in a first plane; and an outlet disposed in a second plane, the outlet fluidly communicating with the inlet by way of a pipe, the pipe having an upper surface and a vented orifice located on the upper surface; wherein an angle is disposed between the first plane and the second plane allowing for flow deflection resulting in increased mixing.

### FIELD OF THE INVENTION

The present invention pertains to the field of tank inlet design and in particular to a hydraulic mixer inlet for a septic or interceptor tank.

### BACKGROUND

Digestion of organic containing liquid such as sewage occurs as naturally occurring micro-organisms break down and digest the organic containing liquid. Over time, organic containing liquid such as sewage generally settles into three substantially distinguishable layers: 1) the bottom sludge layer that contains materials that have a greater density than water, and are derived from much of the solid component; 2) the middle layer comprises liquid and suspended solids, these solids are typically very small organic materials that continue to be degraded while in the liquid layer; and 3) the scum layer, substantially composed of materials that have a lower density than water, such as grease, oil, and fats. Each layer defines a unique microenvironment with different characteristics that support a distinct consortium of microorganisms.

In septic tanks, organic and inorganic solids having a greater density than water settle to the bottom of the tank. Many small organic particles, including bacteria, have very long settling times because they have densities near that of water. In the liquid layer, these particles tend to flocculate into larger masses (enhanced by gentle mixing), thus increasing the settling rate of solids. In the bottom sludge layer where the solids concentration is very high, zone settling occurs whereby the settling sludge blanket further compresses the sludge as liquid is pushed up and out of the sludge layer. In this way, biodegradable nutrients get trapped in the sludge layer where bacteria cannot access them for digestion.

Conventional septic tanks are equipped with a standard inlet baffle or tee at 90 degrees downward relative to the incoming flow. This design dissipates the maximum kinetic energy from the flow, thus reducing the flow velocity to near zero in order to achieve quiescent conditions in the tank to promote maximum settling of solids, with the effect that the rate of digestion is reduced as a result of nutrients settling and getting trapped in the sludge layer where bacteria cannot access them.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a hydraulic mixer inlet for a septic or interceptor tank. In accordance with an aspect of the present invention, there is provided a hydraulic mixer inlet for a septic or interceptor tank having: an inlet for receiving organic containing liquid from a source disposed in a first plane; and an outlet disposed in a second plane, the outlet fluidly communicating with the inlet by way of a pipe, the pipe having an upper surface and a vented orifice located on the upper surface; wherein an angle is disposed between the first plane and the second plane allowing for flow deflection resulting in increased mixing.

### BRIEF DESCRIPTION OF THE FIGURES

Embodiments of the present invention will be better understood in connection with the following Figures, in which:

FIG. 1A illustrates one embodiment of the hydraulic mixer inlet shown installed in a tank;

FIG. 1B illustrates one embodiment of the hydraulic mixer inlet shown installed in a tank;

FIGS. 2A to 2C illustrate one embodiment of the hydraulic mixer inlet detailing the deflector or vent stack on the vented orifice;

FIG. 3 illustrates one embodiment of the hydraulic mixer inlet;

FIG. 4 illustrates a side view of one embodiment of the hydraulic mixer inlet as installed;

FIG. 5 illustrates one embodiment of the hydraulic mixer inlet detailing different geometries that are possible;

FIG. 6 illustrates one embodiment of the hydraulic mixer inlet detailing the decagonal joints between individual components;

FIGS. 7A and 7B illustrates an one embodiment of the hydraulic mixer inlet;

FIG. 8 shows evolution of effluent Biological Oxygen Demand (BOD) in a standard septic tank (Tank 1) and a septic tank with hydraulic mixer inlet installed (Tank 2) during Phase-I.

FIG. 9 shows evolution of effluent Total Suspended Solids (TSS) in the standard septic tank (Tank 1) and a septic tank with hydraulic mixer inlet installed (Tank 2) during Phase-I.

FIG. 10 shows sludge accumulation depth in the standard septic tank (Tank 1) and a septic tank with hydraulic mixer inlet installed (Tank 2) during Phase-I.

FIG. 11 shows evolution of Biological Oxygen Demand (BOD) and percentage BOD removal in the standard septic tank (Tank 1) and a septic tank with hydraulic mixer inlet installed (Tank 2) during Phase-II: (a) evolution of BOD, and (b) % BOD removal.

FIG. 12 shows evolution of Total Suspended Solids (TSS) and percentage TSS removal in the standard septic tank (Tank 1) and a septic tank with hydraulic mixer inlet installed (Tank 2) during Phase-II: (a) evolution of TSS, and (b) % TSS removal.

FIG. 13 shows sludge accumulation depth in the standard septic tank (Tank 1) and a septic tank with hydraulic mixer inlet installed (Tank 2) during Phase-II.

FIG. 14 shows the effect of the hydraulic mixer on mixing incoming raw sewage with mature bacteria in a septic tank with hydraulic mixer inlet installed (Tank 2).

### DETAILED DESCRIPTION OF THE INVENTION

Prior designs of inlet devices for septic and interceptor tanks have focused on dissipating the kinetic energy of the incoming organic containing liquids such as sewage to allow for a quiescent, still tank, which maximizes the settling process. In this way there is minimal disruption of the sludge layer with the influx of fresh material.

In contrast to prior designs, the hydraulic mixer inlet harnesses the flow energy of the incoming sewage or other organic containing liquid to effectively create gentle hydraulic mixing of influent with mature bacteria in the tank. This is facilitated by minimizing the loss in velocity of the transiting influent. By allowing the energy of the incoming influent to be harnessed to mix the influent with mature bacteria populations, bacteria have access to new nutrients and substrates which might otherwise be enclosed in stratified layers of sludge without being digested.

Increasing the degree of mixing increases the solids digestion rate and minimizes the sludge accumulation in the tank. This is a result of improving the solids hydrolysis, developing a homogenous environment in the tank, increasing the contact time between the solubilized organic matter and mature bacteria, and improving the flocculation and settling rate of digested and inert organic matter.

### Definitions

The terms “liquid effluent” and “liquid layer” are used to define substantially liquid portions of the sewage or other organic containing liquids.

The term “sludge” is used to define the materials in organic containing liquid such as sewage that have a density greater than water.

The term “scum” is used to describe the layer which is substantially composed of materials that have a lower density than water.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

### Hydraulic Mixer Inlet Overview

The present invention provides a hydraulic mixer inlet. The hydraulic mixer inlet can be used in any type of liquid-containing vessel or tank where passive hydraulic mixing is desired, where the inflow has sufficient energy that can be directed and transferred to the liquid in the vessel or tank. In some embodiments, the hydraulic mixer inlet is configured for use in a non-pressurized tank while in other embodiments, the hydraulic mixer inlet is configured for use in a pressurized tank. Mixing can be targeted to any location in the vessel by changing the dimensions and angles of the assembly to suit. Examples of applications for the hydraulic mixer inlet are: sewage septic or interceptor tanks, agricultural wastewater treatment tanks or lagoons, industrial process or holding tanks requiring mixing.

By allowing the energy of the incoming organic containing liquid to be harnessed to mix freshly inputted liquid with mature bacteria in the tank, solubilisation of suspended solids in the tank increases, and the contact time increases between the bacteria populations and the solubilized organic solids contained within the liquid resulting in more complete digestion. Mixing increases the solids hydrolysis (solubilisation of suspended particulate matter) which is the first and generally rate-limiting step in anaerobic digestion of complex substrates.

In one embodiment, the hydraulic mixer inlet is for use in a small bore gravity sewer system or septic tank. In such an embodiment, the hydraulic mixer inlet is designed to maximize the digestion which occurs in the tank by promoting mixing of the incoming raw organic containing liquid such as sewage with mature bacteria. The best sludge digestion performance by bacteria occurs during extended periods of anaerobic digestion, whereby bacteria are in extended contact with fresh nutrients and substrates, thus encouraging the growth of mature anaerobic bacteria populations that become more efficient at consuming organics. The hydraulic mixer inlet provides for the exposure of bacteria populations to fresh nutrients and substrates by harnessing the flow energy to deliver influent raw organic containing liquid such as sewage and to solubilize organic solids, thereby promoting digestion and decreasing the solids accumulation.

Some organic solids can only be degraded aerobically, i.e., in environments where oxygen is readily available to facilitate the digestion of nutrients by aerobic bacteria. In one embodiment, the hydraulic mixer inlet may be configured to include air mixing with the influent liquid stream to promote partial aerobic conditions. In such a system, the mixer is designed to increase the concentration of oxygen in the influent organic containing liquid such as sewage. The presence of some small aerobic bacteria population in addition to the dominant anaerobic bacteria populations may enhance the complete digestion of organic solids, thereby decreasing the solids in the tank.

The hydraulic mixer inlet facilitates the maintenance of more uniform environmental conditions by, for example, preventing the formation of unfavourable microenvironments (e.g., unbalanced pH) and by distributing nutrients, buffering agents, and intermediate metabolic products.

The degree of mixing achieved by the hydraulic mixer inlet in the tank may be controlled by the hydraulic flow rate and pattern of the incoming organic containing liquid such as sewage. The flow velocity (energy) and flow distribution pattern (continuous or alternating) determine the flow regime and hydrodynamic properties that contribute to local mixing zones in the tank. Different flow rates and regimes will result in different hydraulic mixing effects such as smaller or larger mixing zones; partial or fully turbulent conditions; and, continuous or alternating mixing patterns. These effects change the rate and degree of transport, dispersion and diffusion of nutrients, substrates and bacteria. Additionally, physical, chemical and biological mechanisms are affected such as settling, solubilisation and hydrolysis of solids, and digestion by bacteria. Hydraulic mixing affects the efficiency of digestion by changing the reaction variables including contact time, reaction kinetics, and the time of reaction.

In one embodiment, the flow rate of the incoming organic containing liquid such as sewage is kept low to promote gentle mixing or partial mixing in a small mixing zone. In one embodiment, the flow rate is kept high to promote more complete mixing in a larger mixing zone.

In one embodiment, the incoming flow pattern is continuous such that well-developed mixing conditions are achieved in the tank. In one embodiment, the flow pattern is alternating or stopped, resulting in pulse flow which creates variable local mixing near the mixer outlet.

The bacteria are more active in local microenvironments with high nutrient and substrate concentrations (biodegradable organic carbon and nitrogen-containing compounds), where the distribution of these depends on the dynamic settling regimes and water chemistry within the tank. Accordingly, in some embodiments, the hydraulic mixer inlet is configured to locally mix new organic containing liquid such as sewage with mature bacteria in the tank. Optionally, the hydraulic mixer inlet is configured to target the clear zone or the sludge layer.

Sludge accumulation rates are retarded as sludge digestion rates increase. The hydraulic mixer inlet by promoting mixing of raw organic containing liquid such as sewage with mature bacteria creates a microenvironment where the bacteria in different layers or zones of the tank are exposed to fresh nutrients and substrates. Mixing the raw organic containing liquid such as sewage provides access to the nutrients and substrates which are normally not available to the matured bacteria populations in quiescent tank conditions. The effect of the hydraulic mixer inlet is twofold, such that fresh nutrients and substrates in the influent raw organic containing liquid such as sewage are conveyed to the biologically-active zones of the tank, and the hydraulic mixing action causes gentle flow patterns in the tank which maintain uniform conditions and expose mature bacteria populations to nutrients and substrates which are not normally available for digestion under quiescent conditions.

In some embodiments, the hydraulic mixer inlet is configured to provide a mixing flow pattern over a larger area or zone within the tank, optionally this effect can be enhanced by providing multiple inlet mixers at appropriate locations in the tank. In some embodiments, the larger area or zone corresponds to substantially the whole tank.

The hydraulic mixer inlet harnesses the flow energy of the incoming organic containing liquid such as sewage to effectively create gentle hydraulic mixing within the tank by reducing the loss in velocity at the entrance of the tank based on geometric configuration. In some embodiments, velocity at the outlet may be optimized by allowing head to build up upstream of the mixer (height of water above the outlet). Optionally, velocity may be increased by adding narrowing/nozzle at outlet (per continuity equation). In some embodiments, the system as a whole is configured to maximize flow velocity. For example, the system may be designed such that flow depth is 75-80% of pipe diameter, thereby maximizing flow velocity (Swan and Horton, 1922). In some embodiments, the building sewer pipe slope and diameter is adjusted to maximize velocity.

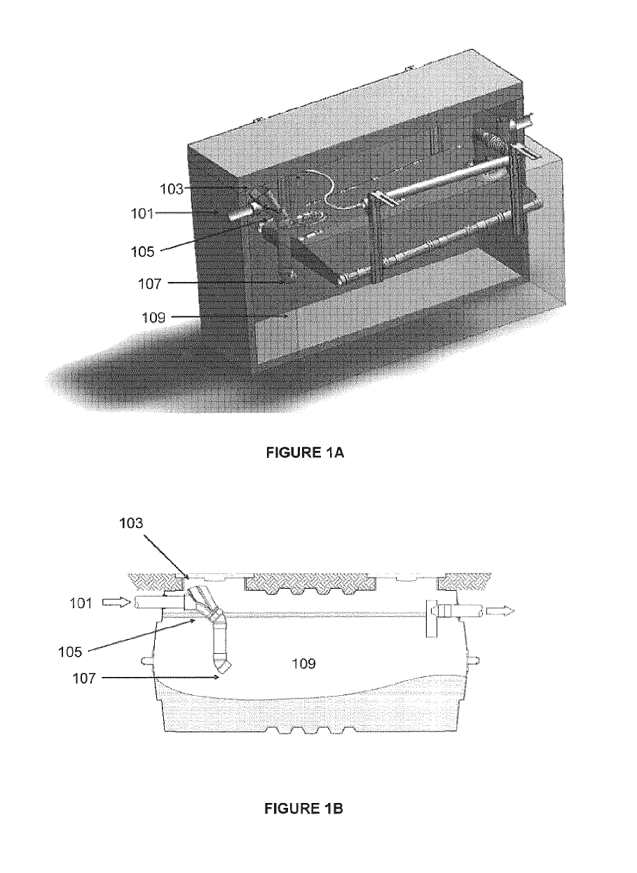

An example of a hydraulic mixer inlet installed in a tank (109) is shown in FIGS. 1A and 1B. In the illustrated embodiments, the inlet (101) receives incoming organic containing liquid such as sewage from a source. The influent liquid flows through a curved pipe (105) having a vented orifice (103) on its upper surface and finally flows out the outlet (107) into the tank. The vented orifice facilitates flow deflection while allowing for circulation of gases to minimize turbulence and provide for controlled flow behavior.

It is contemplated that the hydraulic mixer inlet can be used in a variety of tank configurations and can be specifically adapted for a tank configuration.

In one embodiment, the hydraulic mixer inlet is designed for use in small bore gravity sewage systems.

In such embodiments, sizing of the hydraulic mixer inlet is based on building sewer pipe diameter (e.g., 4″ or 6″) and depth based on height of tank.

In some embodiments, the hydraulic mixer inlet is configured such that the outlet into the tank is positioned at 50% of the tank depth. In other embodiments, the outlet is located at 70% of the tank depth.

In one embodiment, the outlet is located in the clear zone.

In some embodiments, the weight of the hydraulic mixer inlet is supported by the tank wall and the weight of soil above the buried sewer pipe, optionally a brace or strapping between the hydraulic mixer inlet and tank wall is added for support.

### Hydraulic Mixer Inlet Functional Components

The hydraulic mixer inlet comprises a number of functional components working in conjunction to achieve the gentle mixing based on geometry of the arrangement of these components. The hydraulic mixer inlet may be a single unitary structure or a number of connected parts. Individual functional components may be made up of one or more parts. Individual parts may be joined using various means known in the art including chemical adhesives, mechanical joints, and thermal fusion.

In one embodiment, the hydraulic mixer inlet comprises a pipe (straight or with curved sections) with deflection (change in plane from inlet to outlet) and vent hole to prevent siphon effect and air pressure buildup. Optionally, the deflection angle and curve radius are optimized. In other embodiments, deflection angle and curve radius are constrained by system or tank parameters.

The one or more vent holes in the topmost surface of inlet provide for the gas circulation thereby preventing a siphon effect and buildup of air pressure. In some embodiments the vent is sized to allow passage of large solids to avoid clogging. Optionally drain holes located at the base of a vent stack in a deflection plate are provided to allow liquid to pass through down into the mixer.

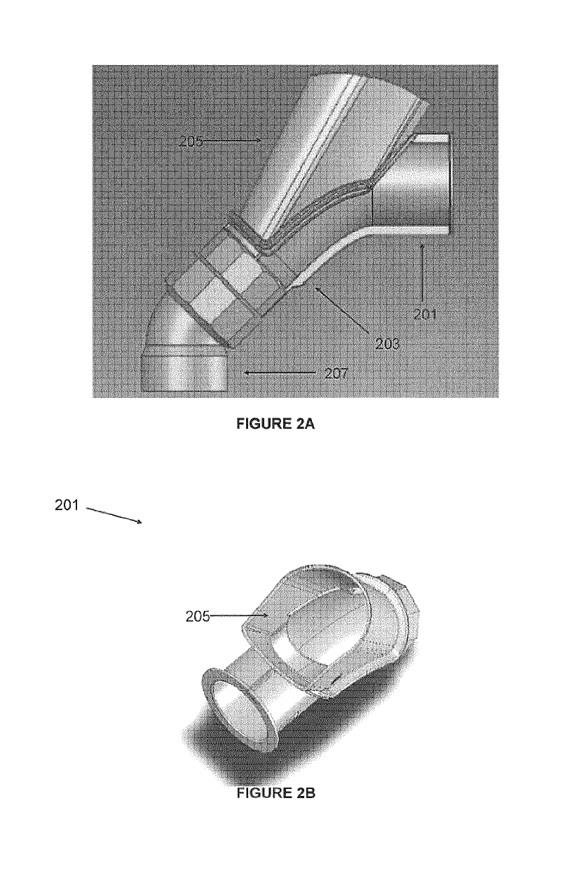

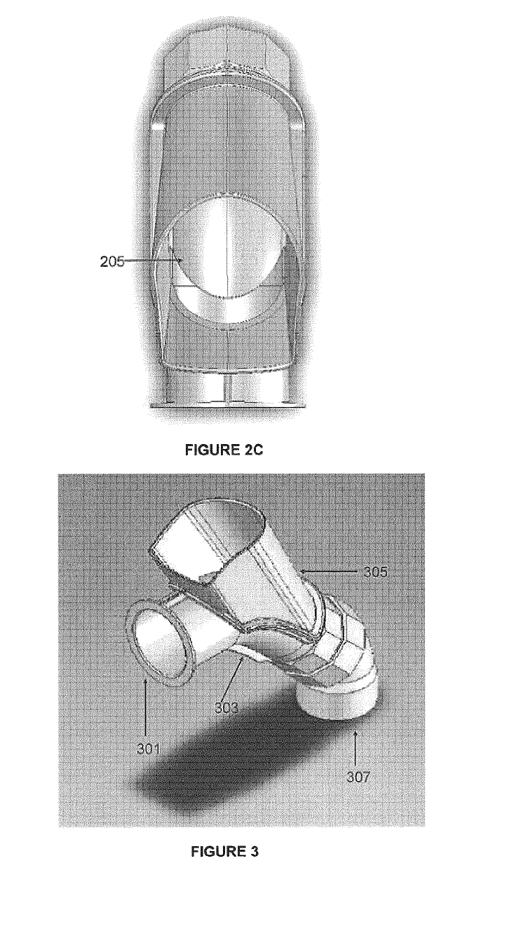

An example of one embodiment of the hydraulic mixer inlet can be seen in FIGS. 2A, 2B and 2C. The inlet of the hydraulic mixer inlet can be seen (201) to be disposed in a first plane relative to the outlet (207) disposed in a second plane. The pipe (203) contained between the inlet and the outlet contains a vented orifice (205) on the upper surface of the pipe.

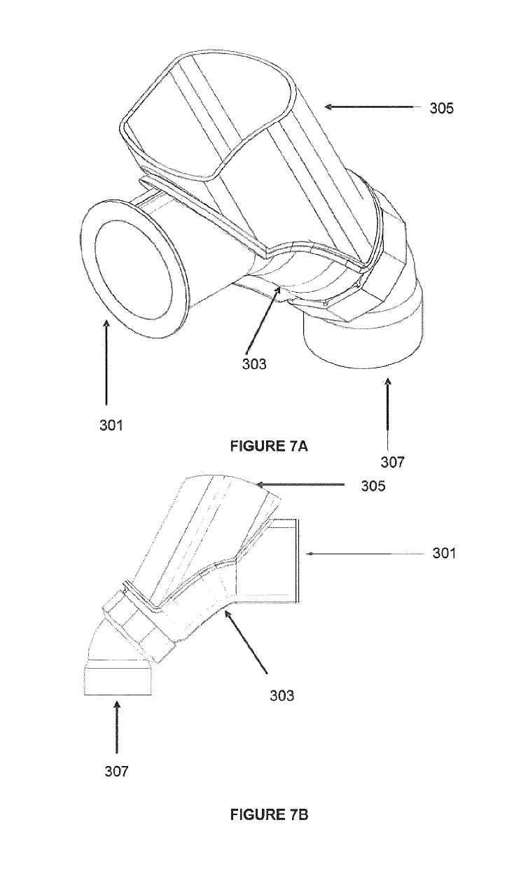

The same embodiment of the hydraulic mixer inlet shown in FIGS. 2A, 2B and 2C can be seen in view in FIG. 3, where the inlet (301), pipe (303), vented orifice (305), and outlet (307) are denoted. FIGS. 7A and 7B show a modification of the hydraulic mixer inlet of FIG. 3 where the inlet (301), pipe (303), vented orifice (305), and outlet (307) are denoted.

The vented orifice, contained on the upper surface of the pipe, is designed to allow for circulation of gases to occur as to minimize turbulence within the inlet such that the flow characteristics may be maintained without loss of velocity.

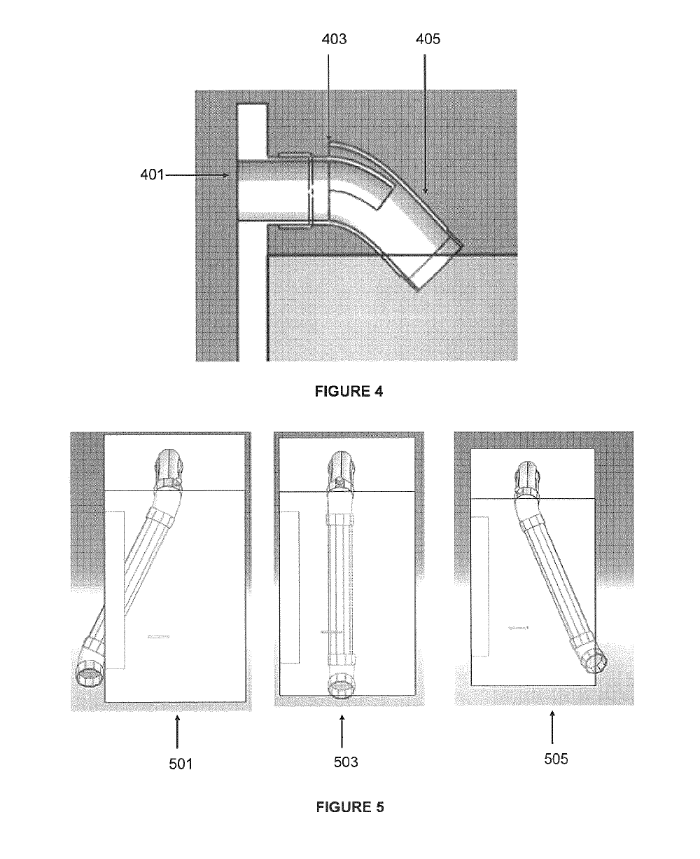

In at least one embodiment, the hydraulic mixer inlet comprises a vented deflector plate to deflect flow and vent gas to regulate flow and minimize turbulence. An example of the deflector plate may be seen in FIG. 4. The inlet (401) is connected to the pipe (405), where the pipe has a vented orifice with a deflector (403) communicating with the vented orifice and the pipe. In at least one embodiment, the deflector has one or more vented holes to aid in circulation. In at least one embodiment, the deflector has two or more vented holes to aid in circulation.

In at least one embodiment, the vented orifice may include an upwardly opening funnel or vent stack as shown in FIG. 2.

In some embodiments, the hydraulic mixer inlet comprises a vent stack configured to allow air and gases to circulate up through the scum layer, and further configured to act as two-way shield to prevent overflow of liquids from the mixer inlet to the top of the scum layer, and solids from the scum layer to the inside of the hydraulic mixer inlet.

In some embodiments, the shape of vent stack is largely governed by moldability and ease of manufacturing.

The orientation of the inlet to the pipe may be in any fashion which allows for the necessary geometry to provide the appropriate mixing. In at least one embodiment, there is an angle disposed between the inlet and the pipe such that the organic containing liquid such as sewage is channeled into a specific area. The curvature of the pipe is to provide the desired change in flow direction while maintaining flow velocity. The angle of deflection in the x-plane may range from 0 to 90 degrees. In at least one embodiment, the flow is directed upward toward the center of the tank.

In at least one embodiment, the inlet may have a piping of 75 mm to 200 mm or any size in between. In at least one embodiment, the inlet has a piping which can be scaled to the project's specifications.

In at least one embodiment, the pipe is continuously curved between the inlet and the outlet.

In at least one embodiment, the pipe is curved at one or more sections between the inlet and the outlet. In this way the flow can be regulated such that there can be multiple intersections (between curved and curved sections) where there is additional change of direction of the organic containing liquid such as sewage such that further mixing is induced.

In at least one embodiment, the pipe is constructed of multiple straight sections with an angle disposed between each section. In this way the flow can be regulated such that there can be multiple intersections (between straight and straight sections) where there is additional change of direction of the organic containing liquid such as sewage such that further mixing is induced. The angle for the intersections will be calculated based on the desired characteristics of rate of change of flow for the liquid. In at least one embodiment, a 45 degree mechanical pipe elbow is used to connect the segments together. In at least one embodiment, the angle is calculated based on fluid dynamic principles known in the art to capture the desired flow rate and is constructed and connected to the segments accordingly.

In at least one embodiment, the pipe is of a variable radius allowing for a control of the flow to either increase or decrease in speed.

In at least one embodiment, the configuration of the pipe and outlet are arranged such that they may be oriented at any position within the tank.

In at least one embodiment, the hydraulic mixer inlet includes a joint. The joint may be geometrically shaped to facilitate appropriate alignment of components.

Optionally, the joint may be configured such that the orientation of the inlet components may be changed in the z-space plane. In some embodiments, the joint has a decagonal configuration or other appropriate geometric shapes. The joint allows for any or all components of the hydraulic mixer inlet to be orientated at a desired position in order to achieve a desired geometry (e.g., 0 to 360 degrees at fixed intervals). One embodiment is shown in FIG. 5. This figure illustrates various positions of the pipe from the inlet based on the position of the joint allowing for custom geometry. In one variation the pipe and outlet are angled left (501) by a specified angle, in another variation the pipe and outlet are not angled and oriented centrally (503), and in yet another variation the pipe and outlet are angled right (505) by a specified angle. The angle of the joint can be adjusted to any of several fixed positions to achieve optimal mixing flow pattern for single or multiple inlet configurations (e.g., multiple hydraulic mixer inlets in at least one tank).

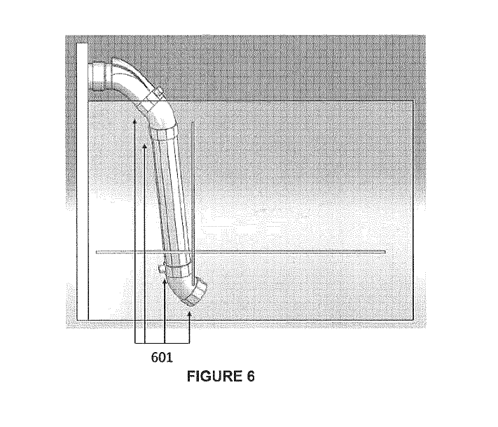

In at least one embodiment, the joint may be implemented using a geometric decagonal configuration. An example of this embodiment can be seen in FIG. 6 which illustrates a decagonal configuration. One of skill in the art would appreciate that alternative configurations could be used for control and ease of assembly and to ensure consistent angling of components. In one embodiment, the hydraulic mixer inlet is made from standard circular pipe and fittings, which can be rotated to any angle (0 to 360 degrees) without fixed positions.

In some embodiments, components of the hydraulic mixer inlet are connected together without the use of a mechanical joint.

### Hydraulic Mixer Construction

The components of the hydraulic mixer inlet may be constructed using a number of techniques. In at least one embodiment, the entire hydraulic mixer inlet is constructed using a unitary construction technique wherein all components are unitary.

In at least one embodiment, the hydraulic mixer inlet is constructed using a segmented manufacturing process which allows for separate components to be manufactured and assembled at a later time. Optionally, mixer components can be pre-assembled or assembled in situ (field) to suit site constraints. This may include the separation of individual inlet components; for example, the pipe may be an inlet component but may also require multiple separate pieces to construct the full pipe.

The separate components are connected using any technique which allows for the integrity of the hydraulic mixer inlet to remain unchanged. In at least one embodiment, the connections of the hydraulic mixer inlet segments are joined using chemical adhesive. In at least one embodiment, the connections of the hydraulic mixer inlet segments are joined using mechanical joints. In at least one embodiment, the connections of the hydraulic mixer inlet segments are joined using thermal fusion.

In at least one embodiment, the components and/or segments of the components are manufactured using a molding process whereby the mold can be set to the specific geometry required to induce the correct flow characteristics.

In some embodiment, standardized (off the shelf) components (pipe, fittings, elbows) can be assembled in proper configuration to achieve a hydraulic mixer inlet design.

The construction of the components may be of any material which allows for the operation of the sewage system. Therefore the material must conform to the durability and temperature metric tests required in order to function to the level of acceptable breakdown threshold. In at least one embodiment, the materials used for the construction of the hydraulic mixer components include acrylonitrile butadiene styrene (ABS) plastic. In at least one embodiment, the materials used for the construction of the hydraulic mixer components include injection molded plastics.

To gain a better understanding of the invention described herein, the following examples are set forth. It will be understood that these examples are intended to describe illustrative embodiments of the invention and are not intended to limit the scope of the invention in any way.

### EXAMPLE

### Field Study Comparing the Effect of Hydraulic Mixing on Septic Tank Performance and Sludge Accumulation

### Study Site

The study was carried out in two (2) single chamber tanks with 3637 L volume each receiving high strength sewage from showers and latrines servicing a work force of approximately 100 people at a labour camp in Bangalore, India. The site contains nine (9) latrines and four (4) showers, which were renovated in preparation for this study. The flow from the latrines and showers was divided into two streams of wastewater: one of these streams flowing into each of the two separate tanks, with each tank receiving approximately 1100 L/day. Tank 1 was configured as a standard septic tank, while Tank 2 was configured as a septic tank with hydraulic mixer inlet. The study was carried out in two phases. In Phase-I (6 months), the wastewater from two (2) showers and five (5) latrine toilets was directed to Tank 1, and the wastewater from two (2) showers and four (4) latrine toilets was directed into Tank 2. During Phase-I, the quantity of wastewater flow going to the two tanks was adjusted to increase the wastewater load on Tank 2 in order to test the performance resilience of Tank 2. For Phase-II (4 months), the plumbing was switched to send the raw sewage previously flowing to Tank 2 to Tank 1, and vice versa.

### Results and Discussion

TABLE 1
Characteristics of raw sewage to Tank
1 and Tank 2 during Phase-II.

| | Tank 1 | | | | Tank 2 | | | |
|---|---|---|---|---|---|---|---|---|
| Parameter | Min | Max | Avg | St. Dev | Min | Max | Avg | St. Dev |
| COD | 2529 | 6674 | 5611 | 1113 | 1860 | 6700 | 5609 | 1167 |
| BOD | 786 | 1885 | 1586 | 300 | 668 | 1910 | 1590 | 311 |
| TSS | 562 | 1794 | 1106 | 218 | 428 | 1680 | 1103 | 226 |
| NH₃—N | 269 | 793 | 624 | 121 | 298 | 817 | 629 | 128 |
| TKN | 302 | 875 | 694 | 147 | 288 | 893 | 699 | 149 |

TABLE 2
Characteristics of the effluent from
Tank 1 and Tank 2 during Phase-II.

| | Tank 1 | | | | Tank 2 | | | |
|---|---|---|---|---|---|---|---|---|
| Parameter | Min | Max | Avg | St. Dev | Min | Max | Avg | St. Dev |
| COD | 1130 | 2367 | 1970 | 294 | 934 | 2182 | 1388 | 291 |
| BOD | 320 | 651 | 542 | 78 | 238 | 613 | 390 | 91 |
| TSS | 217 | 435 | 371 | 53 | 188 | 394 | 309 | 47 |
| NH₃—N | 181 | 348 | 288 | 35 | 175 | 400 | 245 | 49 |
| TKN | 232 | 384 | 336 | 36 | 211 | 353 | 286 | 34 |

The performance of Tank 2 was compared with that of Tank 1 over two phases of operation. The two tanks received high strength sewage from latrines and showers with an estimated average daily flow rate of 1100 L/day to each tank. The parameters used to measure the performance of the tanks were influent and effluent BOD, COD, NH₄, TKN and TSS and their respective removal rates, as well as the sludge accumulation rate in the tanks. All parameters were measured by a third party laboratory. The measurement of these parameters was carried out on a biweekly basis for Phase-I and daily for Phase-II. The daily measurement during Phase-II was carried out by two different laboratories, and the data were presented based on the average value obtained from each laboratory at 95% confidence level. Thus, in most parts of this paper, data analysis and discussion will be based on results obtained from Phase-II.

### Phase-I

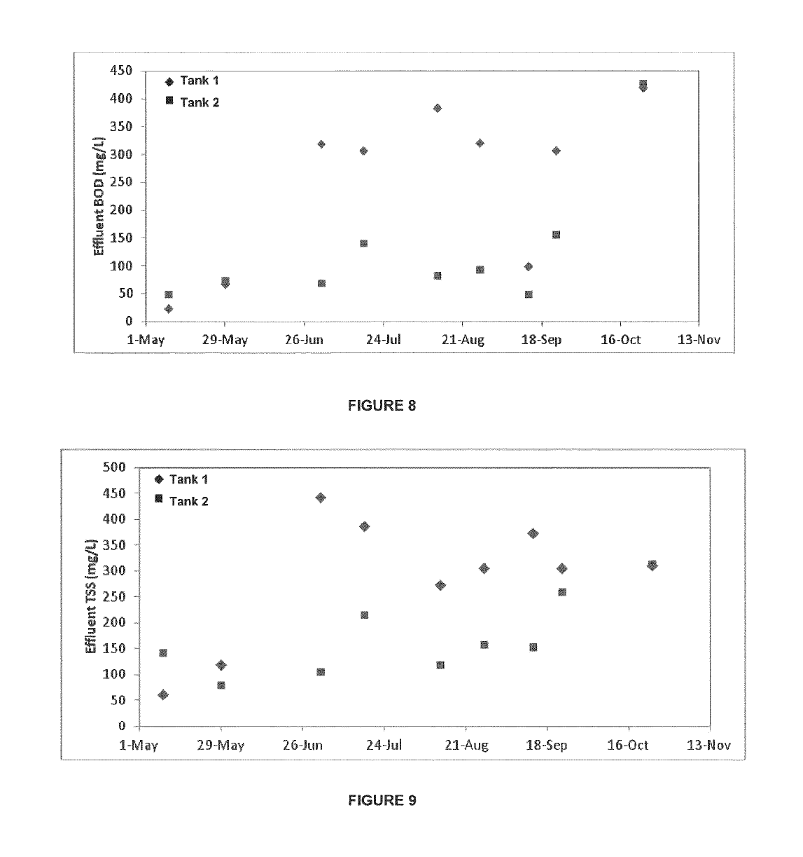

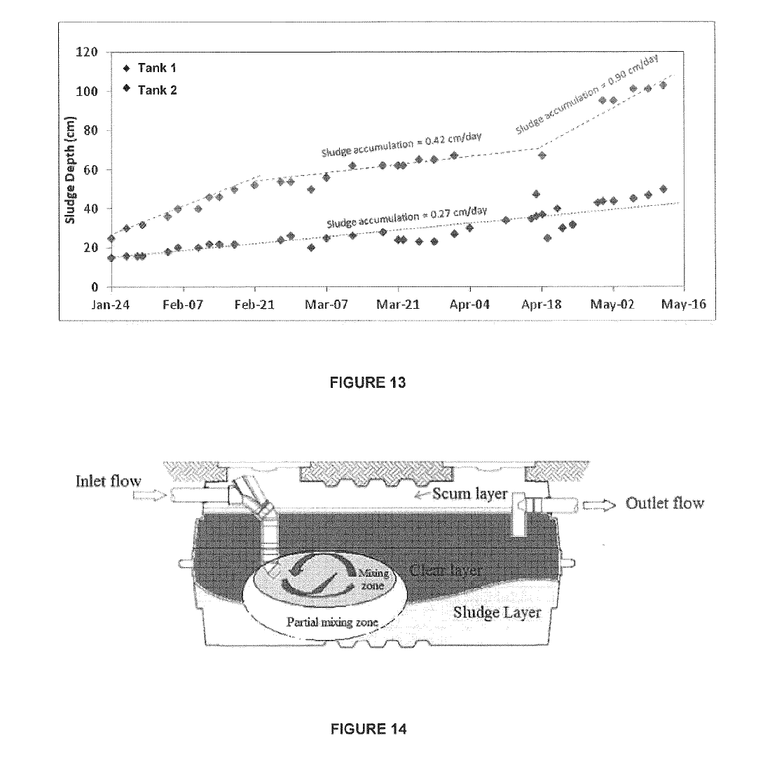

Phase-I was carried out for 6 months with biweekly sampling. FIG. 8 shows the evolution of effluent Biological Oxygen Demand (BOD) for Tank 1 and Tank 2. The average influent BOD to both tanks was 1000±200 mg/L. The overall average BOD removal efficiencies were found to be 48% and 72% for Tank 1 and Tank 2, respectively. The significant difference in BOD removal indicates a higher digestion and settling rate for Tank 2. The mixing process serves to increase the solids hydrolysis (destabilizing colloidal particles allowing them to agglomerate also called coagulation, improve flocculation and settling of solids particles. Gentle mixing creates different velocity zones inside Tank 2 (FIG. 14) and enhance the flocculation of solids particles into larger masses, thus increasing the settling rate and improving effluent quality as observed in this study.

FIG. 9 shows the evolution of effluent Total Suspended Solids (TSS) for Tank 1 and Tank 2 during the operation of Phase-I. The general trends indicate that for most of the testing period the concentration of TSS in the effluent of Tank 2 is less than the TSS in the effluent of Tank 1. The average influent TSS concentration to both tanks was 590±10 mg/L. Overall average effluent TSS for Tank 1 and Tank 2 were 286 and 172 mg/L, respectively. The corresponding TSS removal percentages were found to be 51% and 71% for Tank 1 and Tank 2, respectively.

For both TSS and BOD, it was noticed that the effluent concentration of Tank 2 approaches the same values for Tank 1 by the end of the testing period. It is expected that the variation in measured parameters is related to sampling and analytical errors.

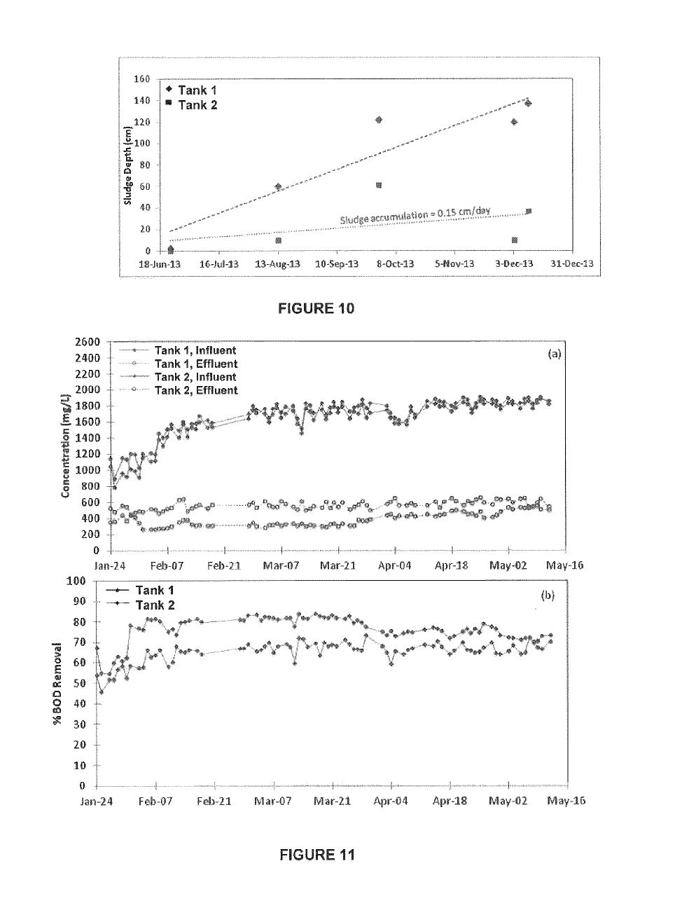

The sludge accumulation in both tanks during Phase-I is presented in FIG. 10. There is a clear trend indicating that the sludge accumulation rate in Tank 2 is lower than in Tank 1. The average rate of sludge accumulation over the 6 month period was 0.72 cm/day for Tank 1 and 0.15 cm/day for Tank 2. The significant difference between the sludge build up in Tank 2 in comparison to Tank 1 indicates that creating gentle mixing inside the tank resulted in an increase in sludge digestion. Further discussion on sludge accumulation is provided below following the analysis of results from Phase-II.

The average influent COD, NH₄-N and TKN concentrations during Phase-I were 4348 mg/L, 185 mg/L and 354 mg/L. The overall average effluent COD, NH₄-N and TKN concentrations were 1305 mg/L, 250 mg/L and 480 mg/L for Tank 1 and 673 mg/L, 127 mg/L and 242 mg/L for Tank 2, respectively. The corresponding COD removal percentages were found to be 70% and 85% for Tank 1 and Tank 2, respectively. It was noticed during Phase-I that while Tank 1 increases the concentration of NH₃-N and TKN, Tank 2 tends to decrease these values. Further discussion on COD and nitrogen compounds is provided below following the analysis of results from Phase-II.

### Phase-II

Phase-II was carried out for 4 months with daily sampling. Tables 1 and 2 show the influent and effluent wastewater characteristics (COD, BOD, TSS, NH4-N and TKN) for both tanks during the 4 months of operation. The fluctuations in influent and effluent TSS, COD and BOD concentrations are typical of raw domestic sewage.

### Influent and Effluent Wastewater Parameters and Removal Rates

FIGS. 11a and 11b show the evolution of influent, effluent, and percentage removal of BOD for Tank 1 and Tank 2 during Phase-II. The influent BOD to both tanks is comparable with a difference of no more than 10%. The average influent BOD values were 1586 and 1590 mg/L for Tank 1 and Tank 2, respectively. There was a noticeable difference between the effluent BOD of both tanks; the average effluent BOD from Tank 1 and Tank 2 was 542 and 390 mg/L, respectively. The average percent removal of BOD was found to be 65% and 75% for Tank 1 and Tank 2, respectively (FIG. 11b). As both tanks received raw sewage from the same source, the difference in performance between Tank 2 and Tank 1 can be related to the effect of hydraulic mixing.

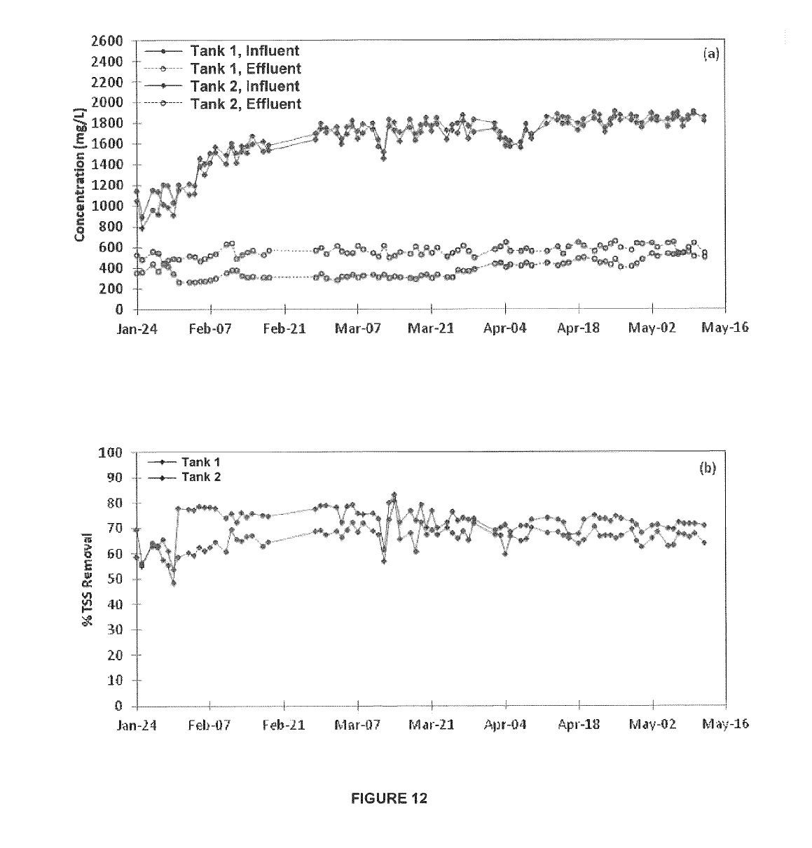

The evolution of influent, effluent, and percentage removal of TSS for Tank 1 and Tank 2 during Phase-II are presented in FIGS. 12a and 12b. The influent TSS to both tanks fluctuates around the same average value of 1100±10 mg/L. The average effluent TSS was found to be 371 and 309 mg/L for Tank 1 and Tank 2, respectively. This corresponds to an average TSS removal of 66% and 72%, respectively. As both tanks operated under the same conditions, Tank 2 has notably better performance than Tank 1.

Other tested parameters (COD, NH₄ and TKN) were consistent in indicating that the performance of Tank 2 was better than Tank 1. The overall average removals for COD, NH₄ and TKN were 64% (75%), 54% (61%) and 51% (59%) for Tank 1 (and Tank 2), respectively. Experimental results show that the use of the hydraulic mixer inlet enhanced the digestion process with minimal nutrient production. Specifically, COD and ammonia removals were greater in Tank 2 in comparison to Tank 1, indicating that gentle hydraulic mixing inside the tank was effective in establishing optimum growth conditions for heterotrophic facultative anaerobic bacteria (such as Paracoccus denitrificans and various pseudomonads) that acted to reduce nitrogen compounds in the wastewater. Further follow up to these parameters is required to confirm the observed trend.

### Sludge Accumulation

The accumulation of sludge in both tanks is presented in FIG. 13. The accumulation of sludge in Tank 2 is much less than that in Tank 1. The overall rate of sludge accumulation for Tank 2 was found to be constant over the 4 month period at 0.27 cm/day (9.1 L/day). On other hand, the sludge accumulation in Tank 1 changes with time; the accumulation rate during the startup period was very high 0.98 cm/day, then the rate decreased from February to April to approximately 0.42 cm/day, and then increased again from April to May to 0.90 cm/day. The overall rate of sludge accumulation in Tank 1 based on 95% confidence level was found to be 0.64 cm/day (21.5 L/day). Therefore, the observed sludge accumulation rate in Tank 2 is 57% lower than that in Tank 1. This indicates that a larger portion of the biodegradable organic matter that entered Tank 2 was degraded while only a small portion of this organic matter, in addition to inert material, accumulated in the tank. Based on the observed sludge accumulation rates, the pump-out interval of Tank 2 is approximately 3 times longer than that for Tank 1. It was noticed previously that the effluent TSS from Tank 2 is lower than the effluent TSS from Tank 1 which results in a higher level of solids remaining in the tank. However, the sludge accumulation in Tank 2 is much less than sludge accumulation in Tank 1 indicating a higher rate of digestion in Tank 2.

### Pump-Out Interval

Septage pump-out intervals depend on a number of operating factors such as the permitted level of sludge inside the tank, the thickness of the scum layer, or both (scum and sludge). The permitted level of sludge accumulation in the tank is also an important parameter that influences the effluent solids concentration. The pump-out level is determined to correspond with a permitted level of TSS in effluent from the tank. The pump-out level is either regulated by the district in which the tank is located or based on professional recommendations, which are intended to assure the quality of effluent typically in order to protect the field bed for subsurface disposal.

Measuring the sludge accumulation in both tanks allows for the estimation of the appropriate pump-out intervals for Tank 1 and Tank 2. During Phase-II, the sludge depth in both tanks was measured daily (FIG. 13). Tank 1 required pump-out after approximately 4 months of operation. The sludge accumulation rate (0.27 cm/day) in Tank 2 indicates that the expected pump-out for that tank will be after 12 months of operation. The significant difference in expected pump-out intervals between Tank 1 (4 months) and Tank 2 (12 months) suggests that Tank 2 will have a pump-out interval of approximately 3 times longer than Tank 1.

### Performance Efficiency and the Effect of Hydraulic Mixing

Septic tanks are classified as being either operationally efficient or deficient, based on the average stabilized rate of sludge accumulation in the tank. An efficient tank is considered to have a sludge accumulation rate below 0.175 L/person/day, a medium efficiency tank has values between 0.175 and 0.225 L/person/day, and a deficient tank has sludge accumulation above 0.225 L/person/day. Using this classification, and based on approximately 100 people using each of the tanks in the present study, Tank 2 can be considered a super-efficient tank with the sludge accumulation rate of approximately 0.09 L/person/day. In comparison, Tank 1 performed as a medium efficiency tank with a sludge accumulation rate of 0.21 L/person/day.

The high performance observed by Tank 2 can be explained by the role of the hydraulic mixer inlet in improving the rate of solids digestion. The objective of the hydraulic mixer inlet is to harness the kinetic energy of the incoming sewage to effectively create gentle hydraulic mixing of raw sewage with mature bacteria in Tank 2. The mixing process serves to create a more homogenous environment throughout the tank with a more even distribution of temperature, raw sewage, active biomass, and metabolic microbial waste products. It is expected that gentle mixing will create two small mixing zones, as shown in FIG. 14, where organic matter and bacteria will be in contact for a longer time. In addition, gentle mixing in Tank 2 will increase the solids hydrolysis (solubilisation of suspended particulate matter) which is the first and generally rate-limiting step in anaerobic digestion of complex substrates. Gentle mixing will also create different velocity zones inside Tank 2 (FIG. 14) and enhance the flocculation of solids particles into larger masses, thus increasing the settling rate and improving effluent quality as observed in this study.

### Conclusions

Side by side septic tanks receiving high strength raw sewage were operated over a period of 10 months to investigate the effect of mixing on septic tank performance and sludge accumulation.

Tank 2 tank equipped with the hydraulic mixing device improved the effluent wastewater characteristics (BOD and TSS), reduced sludge accumulation in the tank by 57%, and increased the expected pump-out interval by a factor of approximately 3 compared to Tank 1.

The solids digestion efficiency was improved by hydraulic mixing, as a result of developing a more homogenous environment throughout the tank, increasing the contact time between solubilized organic matter and mature bacteria, and improving flocculation and the settling rate of digested and inert organic matter.

Mixing increases the solids hydrolysis (solubilisation of suspended particulate matter) which is the first and generally rate-limiting step in anaerobic digestion of complex substrates.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A hydraulic mixer inlet for a septic or interceptor tank comprising:
an inlet for receiving organic containing liquid from a source disposed in a first plane; and
an outlet disposed in a second plane, the outlet fluidly communicating with the inlet by way of a pipe, the pipe having an upper surface and a vented orifice located on the upper surface;
wherein an angle is disposed between the first plane and the second plane allowing for flow deflection resulting in increased mixing.

2. The hydraulic mixer inlet of claim 1, wherein the pipe is curved between the inlet and the outlet.

3. The hydraulic mixer inlet of claim 2, wherein the pipe is smoothly and continuously curved between the inlet and the outlet.

4. The hydraulic mixer inlet of claim 2, wherein the pipe is further comprised of a plurality of curved sections with each of the plurality of curved sections having a varied curvature relative to at least one of the plurality of curved sections.

5. The hydraulic mixer inlet of claim 1, wherein the pipe further comprises a first straight section connected to and fluidly communicating with a second straight section, the second straight section connected to and fluidly communicating with a third straight section, wherein each of the first straight section, second straight section and third straight section are oriented such that an angle is disposed there between.

6. The hydraulic mixer inlet of claim 1, wherein the pipe further comprises a joint located between the inlet and the outlet, the joint configured to a desired geometry.

7. The hydraulic mixer inlet of claim 6, wherein the joint has a geometric configuration.

8. The hydraulic mixer inlet of claim 7, wherein the joint has a decagonal configuration.

9. The hydraulic mixer inlet of claim 1, wherein the vented orifice further comprises a deflector, the deflector fluidly communicating with the vented orifice and the pipe.

10. The hydraulic mixer inlet of claim 1, wherein the vented orifice further comprises an upwardly opening vent stack.

11. The hydraulic mixer inlet of claim 1, wherein the inlet, outlet, pipe, and vented orifice are a unitary component.

12. The hydraulic mixer inlet of claim 1, wherein at least one of the inlet, outlet, pipe, and vented orifice are separate components.

13. The hydraulic mixer of claim 1, wherein the inlet, outlet, pipe, and vented orifice are constructed by a molding manufacturing technique.

14. The hydraulic mixer of claim 1, wherein at least one of the inlet, outlet, pipe, and vented orifice are standardized pieces.

15. The hydraulic mixer of claim 1, wherein the organic containing liquid is sewage.
